(19) United States
(12) Patent Application Publication
(10) Pub. No.: US 2012/0039457 A1
(43) Pub. Date: Feb. 16, 2012

(54) TELECONFERENCING CONTROL SYSTEM AND METHOD

(75) Inventors: Ching-Fu Liao, Taipei (TW); Yu-Jheng Lin, Taipei (TW)

(73) Assignee: CHUNGHWA TELECOM CO., LTD., Taipei (TW)

(21) Appl. No.: 13/017,030

(22) Filed: Jan. 30, 2011

(30) Foreign Application Priority Data
Aug. 16, 2010 (TW) 099127246

(51) Int. Cl. H04M 3/42

(52) U.S. Cl. 379/202.01

(57) ABSTRACT

Teleconferencing control system and method are provided for an administrator to log in a setting interface supplied in the system via any network terminal, so as to input relevant setting information comprising identification information of each teleconferencing location to be controlled, and control parameters of its teleconferencing equipment terminal, through the stored identification information of each teleconferencing location and control parameter information corresponding to the teleconferencing equipment terminal at each teleconferencing location and, to perform a control operation with respect to the teleconferencing equipment terminal of each corresponding teleconferencing location via a multi-point control unit, thereby providing centralized control for a group of teleconferencing so as to provide perfect teleconferencing service and thus increase work efficiency.

### BACKGROUND OF THE INVENTION

1. Field of the Invention

This invention relates to teleconferencing equipments, and more particularly, to a teleconferencing control system and method for controlling a plurality of teleconferencing equipment terminals at different teleconferencing locations.

2. Description of Related Art

Following with the development and improvement of technology, electrical and electronic equipments (for instance, audio equipments, video equipments or lighting systems) of a modern conference room are getting popular. A great number of various kinds of remote controllers and equipment switches are often disposed in the conference room. Operating these equipments usually confuses a holder of a conference, resulting in not only wasting time but also decreasing the effect.

Following with population of a group of teleconferencing, a control problem between multi points of teleconferencing is generated. The existing teleconferencing location in each region merely performs home control according to teleconferencing equipment terminals disposed at the teleconferencing location, without controlling other remote teleconferencing locations at the same time. Thus, during a group of teleconferencing, if a teleconferencing equipment terminal in some region can not be operated successfully while relevant technical staffs can not provide assistance immediately, it will affect execution of overall teleconferencing.

### SUMMARY OF THE INVENTION

In view of the above-mentioned problems of the prior art, it is a primary objective of the present invention to provide teleconferencing control system and method for conveniently performing centralized control with respect to a teleconferencing location in each region.

It is another objective of the present invention to provide teleconferencing control system and method for integrating a teleconferencing equipment terminal at each teleconferencing location through providing a well-designed user operation interface so as to facilitate more simple operation with respect to a teleconferencing equipment.

In order to achieve the above and other relevant objectives, the present invention provides a teleconferencing control system for controlling a plurality of teleconferencing equipment terminals at different teleconferencing locations, the system comprising a database for storing identification information of the teleconferencing locations and control parameter information corresponding to the teleconferencing equipment terminals, a setting module for providing a setting interface according to the identification information and the control parameter information stored in the database, so as to receive the identification information of the teleconferencing location to be controlled and set corresponding control parameters with respect to the teleconferencing equipment terminal at the inputting teleconferencing location, an executing module for a multi-point control unit to control the teleconferencing equipment terminal corresponding to the teleconferencing location to perform an operation according to the identification information and the control parameters inputted by the setting module, and a capturing module for capturing current work status information of the teleconferencing equipment terminal at each teleconferencing location and for providing an output function.

The teleconferencing equipment terminal comprises a network access device and a location control host. The location control host comprises a power controller and a matrix manager. A sounder, a television, a codec, a DVD digital camcorder, a projector and a lighting equipment are respectively connected to the power controller and the matrix manager of the location control host.

In an embodiment of the present invention, the setting module further provides a schedule setting interface for predetermining and inputting schedule information comprising the identification information of the teleconferencing location to be controlled, the control parameters of the teleconferencing equipment terminal at the teleconferencing location and execution time of the teleconferencing equipment terminal. The executing module further enables the multi-point control unit to automatically control the teleconferencing equipment terminal at each teleconferencing location at specified timing to perform a corresponding operation according the schedule information predetermined and inputted by the setting module.

Additionally, the present invention further provides a teleconferencing control method for controlling a plurality of teleconferencing equipment terminals at different teleconferencing locations, the method comprising collecting and storing identification information of the teleconferencing locations and control parameter information corresponding to the teleconferencing equipment terminals, providing a setting interface according to the stored identification information and the control parameter information, so as to input the identification information of the teleconferencing location to be controlled and set corresponding control parameters with respect to the teleconferencing equipment terminal at the inputting teleconferencing location, controlling the teleconferencing equipment terminal corresponding to the teleconferencing location to perform an operation according to the identification information and the control parameters inputted in the previously described setting interface by a multi-point control unit, and capturing current work status information of the teleconferencing equipment terminal at each teleconferencing location and providing an output function.

In an embodiment of the teleconferencing control method in accordance with the present invention, the method further comprises providing a schedule setting interface for predetermining and inputting schedule information including the identification information of the teleconferencing location to be controlled, the control parameters of the teleconferencing equipment terminal at the teleconferencing location and execution time of the teleconferencing equipment terminal, and automatically controlling the teleconferencing equipment terminal at each teleconferencing location by the multi-point control unit at a specified timing to perform a corresponding operation according the schedule information predetermined and inputted by a setting module.

According to the teleconferencing control system and method of the present invention, it may perform centralized control with respect to a group of the teleconferencing, and an administrator may control the teleconferencing equipment terminal at each teleconferencing location merely by logging in the setting interface provided by the present invention through a network terminal, such as a mobile phone, a computer, without any space limitation, and may conveniently perform centralized control with respect to the teleconferencing location in each region, thereby facilitating a simple operation with respect to the teleconferencing equipment.

### BRIEF DESCRIPTION OF DRAWINGS

FIG. 1 illustrates a schematic diagram of a teleconferencing control system applicable in a network environment in accordance with the present invention;

FIG. 2 illustrates a block diagram of a teleconferencing control system and a teleconferencing equipment terminal at a teleconferencing location connected to the teleconferencing control system in accordance with the present invention; and

FIG. 3 illustrates a flow chart of a teleconferencing control method in accordance with the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The disclosure can also be performed or applied by other different embodiments. The details of the specification may be on the basis of different points and applications, and numerous modifications and variations can be devised without departing from the spirit of the disclosure.

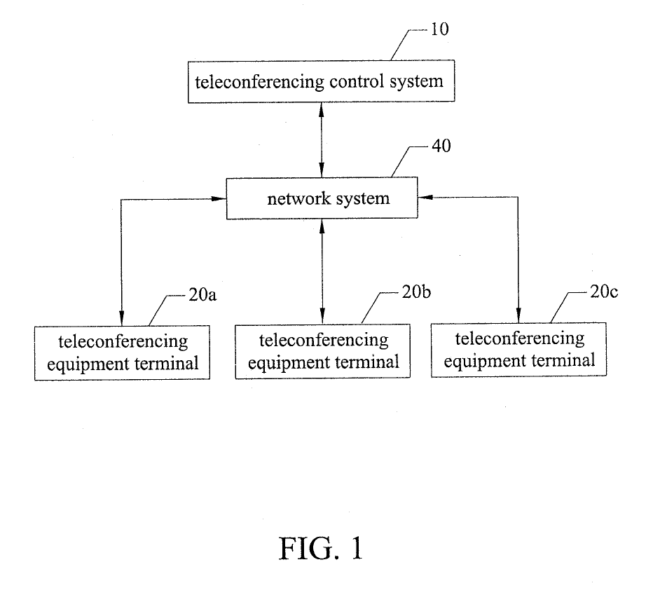

FIG. 1 illustrates a schematic diagram of a teleconferencing control system 10 applicable in a network environment in accordance with the present invention. The teleconferencing control system 10 is a network management service platform, for example, and is connected via a network system 40 to a plurality of teleconferencing equipment terminals (20a, 20b and 20c) at different teleconferencing locations arranged in different regions, so as to achieve the objective of performing centralized management with respect to a group of teleconferencing.

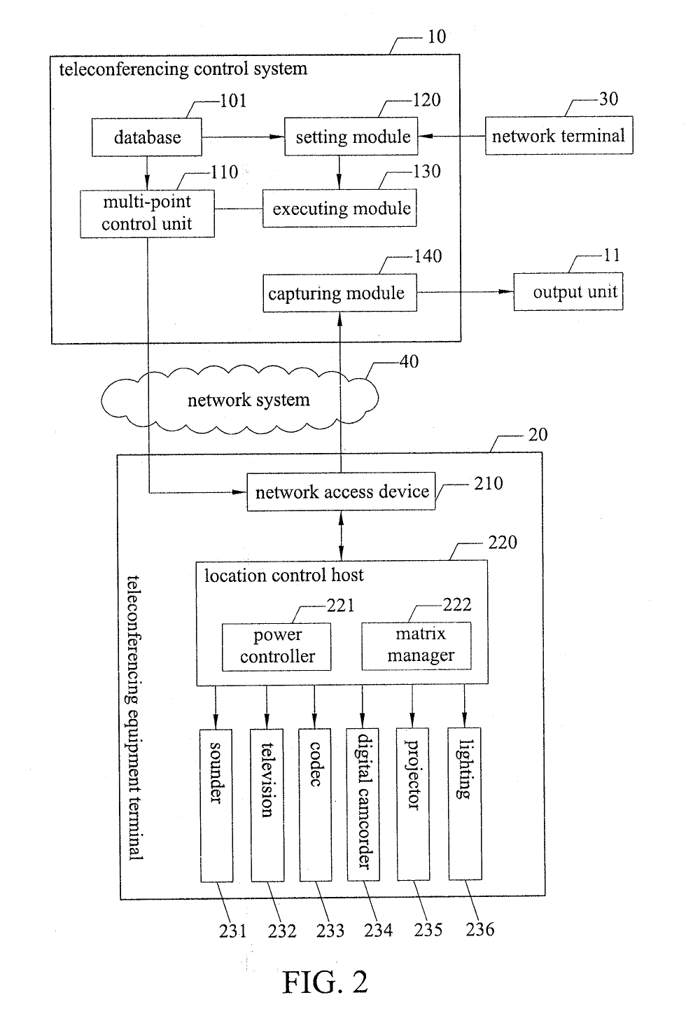

FIG. 2 illustrates a block diagram of the teleconferencing control system 10 and a teleconferencing equipment terminal at a teleconferencing location in a predetermined region in accordance with the present invention. The teleconferencing control system 10 disposed in the network environment and the teleconferencing equipment terminal 20 communicates with each other through a network system 40. The teleconferencing equipment terminal 20 comprises a network access device 210 and a location control host 220. The teleconferencing equipment terminal 20 at the teleconferencing location in each different region is connected to the network system 40 by Asymmetric Digital Subscriber Line (ADSL), Integrated Services Digital Network (ISDN), optical fiber access, or wireless network through the network access device 210 so as to realize remote control. The location control host 220 comprises a power controller 221 and a matrix manager 222, which are connected to a sounder 231, a television 232, a codec 233, a DVD digital camcorder 234, a projector 235, or a lighting 236. All of the teleconferencing equipments previously described perform centralized power switching management by the power controller 221 and thus avoid trouble of sequentially switching power of the teleconferencing equipments by an operator while processing IO operation of different types of video signals through video matrix switch function provided by the matrix manager 222.

As illustrated in FIG. 2, the teleconferencing control system 10 comprises a database 101, a multi-point control unit 110, a setting module 120, an executing module 130 and a capturing module 140.

The database 101 is used to store identification information corresponding to the teleconferencing location in each different region and control parameter information corresponding to the teleconferencing equipment terminal 20 arranged at each teleconferencing location.

The multi-point control unit (MCU) 110 is connected with the teleconferencing equipment terminal 20 at each teleconferencing location through the network system 40, and is responsible to process network access of each teleconferencing equipment terminal 20 and multimedia information.

The setting module 120 is used to provide a setting interface according to the identification information and the control parameter information stored in the database, so as to provide for an administrator to input the identification information at the teleconferencing location to be controlled and to set relevant control parameters with respect to all kinds of teleconferencing equipments (the sounder, the television, or the codec) connected to the teleconferencing equipment terminal at the teleconferencing location. The administrator may log in the setting interface provided by the setting module 120 to perform an input operation of the relevant setting information previously described, such as the identification information and the control parameter information, by using a network terminal 30, such as a mobile phone or a computer. Compared to merely controlling a teleconferencing equipment of a home terminal in the prior art, the present invention may freely perform controlling with respect to home or remote teleconferencing equipment terminals without limitation of any space. Additionally, the previously described setting operation of control parameters of the teleconferencing equipment terminal 20 may also be accomplished by a way of default circumstance mode.

The executing module 130 is used to enable the multi-point control unit 110 to control performing operation of the teleconferencing equipment terminal 20 at the teleconferencing location in a relevant region according to the identification information at the teleconferencing location to be controlled and the relevant setting parameter information of the teleconferencing equipment terminal 20 at the teleconferencing location inputted by the setting module 120.

The capturing module 140 is used to capture current work status information of the teleconferencing equipment terminal 20 at the teleconferencing location and to provide an output function. Particularly, the capturing module 140 is used to collect the current work status information of all kinds of teleconferencing equipments (the previously described sounder 231 and television 232, for example) connected to the teleconferencing equipment terminal 20 at the teleconferencing location, such as closed/open status or normal/abnormal operational status. The previously described work status information captured by the capturing module 140 is outputted to an output unit 11, and the output unit 11 outputs the previously described work status information to a display screen or a mobile phone via a message way, such that the administrator may take the work status information as a reference and remotely controls the teleconferencing equipment terminal 20. Hence, during a group of teleconferencing, when the teleconferencing equipment terminal 20a in some region cannot successfully communicate with the teleconferencing equipment terminals 20b and 20c in other regions, and no relevant equipment administrators are assigned to the region or the equipment administrators assigned to the region do not find solutions temporarily, the equipment administrator in any of the other regions may remotely take over the control rights of the teleconferencing equipment terminal 20a at the teleconferencing location in the region through the teleconferencing control system 10 provided by the present invention, so as to provide assist in handling and thus ensure successive execution of the group of the teleconferencing.

The database 101, the setting module 120 and the executing module 130 of the teleconferencing control system 10 may be incorporated and disposed in an independent server (not shown). The server is connected to the multi-point control unit 110 through the network system, allowing the multi-point control unit 110 to control performing operation of the teleconferencing equipment terminal 20 at the corresponding teleconferencing location according to the previously described identification information and the control parameter information inputted by the setting module 120. In other words, the teleconferencing control system of the present invention has different system architectures according to the implementing aspect without limitation of FIG. 2.

Furthermore, the teleconferencing control system 10 further comprises a conference scheduling function. Particularly, the setting module 120 of the present invention may further provide for the administrator to predetermine relevant conference schedule information with respect to the teleconferencing location in each region via the schedule setting interface supplied by the setting module 120. For example, the relevant predetermined conference schedule information comprising the identification information at the teleconferencing location to be controlled, the control parameters of the teleconferencing equipment terminal at the teleconferencing location, and corresponding execution time is inputted through the schedule setting interface to provide for the executing module 130 to enable the multi-point control unit 110 to automatically start at the specified time to control the teleconferencing equipment terminal 20 at each teleconferencing location to perform corresponding operation according to the predetermined inputting conference schedule information previously described.

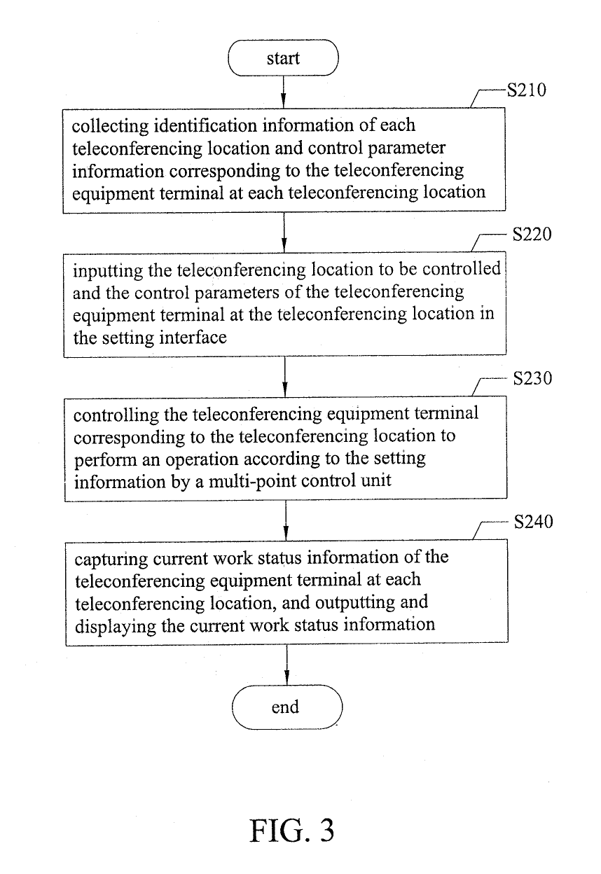

Next, a processing flow of a teleconferencing control method in accordance with the present invention is illustrated in conjunction with the system architecture shown in FIG. 2. FIG. 3 illustrates a flow chart of the teleconferencing control method in accordance with the present invention. As illustrated, step S210 is first performed to establish the database 101 according the collected identification information of the teleconferencing location in each region and the control parameter information corresponding to the teleconferencing equipment terminal 20 at each teleconferencing location. Then, step S220 is performed.

In step S220, a setting interface is provided according to the stored identification information and the control parameter information in step S210 for the administrator to input the identification information of the teleconferencing location to be controlled and to set corresponding control parameters with respect to all kinds of teleconferencing equipments (the previously described sounder, the television and the codec) connected to the teleconferencing equipment terminal at the inputted teleconferencing location. Then, step S230 is performed.

In step S230, the teleconferencing equipment terminal at the teleconferencing location in corresponding region is controlled by the multi-point control unit 110 to perform execution according to the relevant setting information of the inputted identification information and the control parameter information in the previously described setting interface. Then, step S240 is performed.

In step S240, the current work status information of the teleconferencing equipment terminal at each teleconferencing location is captured and then outputted for display.

Moreover, the teleconferencing control method may further provide the conference scheduling function. The administrator inputs the predetermined schedule information comprising the identification information of the teleconferencing location to be controlled, the control parameters of the teleconferencing equipment terminal at the teleconferencing location and execution time according to the provided setting interface or another setting interface (schedule setting interface) previously described such that the multi-point control unit 110 automatically controls the teleconferencing equipment terminal 20 at each teleconferencing location at the specified time to perform corresponding operation.

In conclusion, the teleconferencing control system and method of the present invention may conveniently perform centralized control with respect to the group of the teleconferencing through provision of perfectly united operation interface. Additionally, since the teleconferencing equipment terminals at the teleconferencing locations in different regions are integrated, it facilitates more simple operation. Moreover, it may extremely increase work efficiency while operating work does not have any space limitation.

The foregoing descriptions of the detailed embodiments only exemplarily illustrate the implementing aspect of the teleconferencing control system and method in accordance with the present invention and not restrictive of the scope of substantial technique contents of the present invention. The teleconferencing control system and method and their substantial technique contents in accordance with the present invention are defined on the basis of generalized form in the appended claims. Any technical substance or method accomplished by others will be considered to fall within the scope of the appended claims if totally equaling to or being an equivalent modification of the define in the appended claims.

What is claimed is:

1. A teleconferencing control system for controlling a plurality of teleconferencing equipment terminals at different teleconferencing locations, comprising:
a database for storing identification information of the teleconferencing locations and control parameter information corresponding to the teleconferencing equipment terminals;
a multi-point control unit connected to the teleconferencing equipment terminals for processing network accesses and multimedia information of the teleconferencing equipment terminals;
a setting module for providing a setting interface according to the identification information and the control parameter information stored in the database, the setting interface receiving the identification information of the teleconferencing location to be controlled and setting corresponding control parameters of the teleconferencing equipment terminal that is located at the teleconferencing location;
an executing module for providing the multi-point control unit to control the teleconferencing equipment terminal at the corresponding teleconferencing location to perform an operation according to the identification information and the control parameters received by the setting module; and
a capturing module for capturing current work status information of the teleconferencing equipment terminals at the teleconferencing locations and for providing an output function.

2. The teleconferencing control system of claim 1, wherein at least one of the teleconferencing equipment terminals comprises a network access device and a location control host.

3. The teleconferencing control system of claim 2, wherein the network access device comprises an ADSL, ISDN, optical fiber access or wireless network access device.

4. The teleconferencing control system of claim 2, wherein the location control host comprises a power controller and a matrix manager.

5. The teleconferencing control system of claim 4, wherein the power controller and the matrix manager of the location control host are connected to a sounder, a television, a codec, a DVD digital camcorder, a projector and a lighting equipment, respectively.

6. The teleconferencing control system of claim 1, wherein the setting module further provides a schedule setting interface for predetermining and inputting schedule information comprising the identification information of the teleconferencing location to be controlled, the control parameters of the teleconferencing equipment terminal at the teleconferencing location and execution time of the teleconferencing equipment terminal.

7. The teleconferencing control system of claim 6, wherein the executing module further enables the multi-point control unit to automatically control the teleconferencing equipment terminals at the teleconferencing locations at specified time to perform a corresponding operation according the schedule information predetermined and inputted by the setting module.

8. The teleconferencing control system of claim 1, wherein relevant setting information is inputted through logging in the setting interface provided by the setting module via a network terminal.

9. A teleconferencing control method for controlling a plurality of teleconferencing equipment terminals at different teleconferencing locations, comprising:
collecting and storing identification information of the teleconferencing locations and control parameter information corresponding to the teleconferencing equipment terminals;
providing a setting interface according to the stored identification information and the control parameter information, so as to input the identification information of the teleconferencing location to be controlled and set corresponding control parameters of the teleconferencing equipment terminal at the teleconferencing location;
controlling the teleconferencing equipment terminal corresponding to the teleconferencing location to perform an operation according to the identification information and the control parameters inputted in the setting interface by a multi-point control unit; and
capturing current work status information of the teleconferencing equipment terminals at the teleconferencing locations and providing an output function.

10. The teleconferencing control method of claim 9, further comprising providing a schedule setting interface for predetermining and inputting schedule information including the identification information of the teleconferencing location to be controlled, the control parameters of the teleconferencing equipment terminal at the teleconferencing location and execution time of the teleconferencing equipment terminal.

11. The teleconferencing control method of claim 10, further comprising automatically controlling the teleconferencing equipment terminals at the teleconferencing locations by a multi-point control unit at specified time to perform a corresponding operation according the schedule information predetermined and inputted by a setting module.
